(19) United States
(12) Patent Application Publication
(10) Pub. No.: US 2010/0258969 A1
(43) Pub. Date: Oct. 14, 2010

(54) METHOD FOR PRODUCTION OF MOLDED THERMOPLASTIC COMPOSITION ARTICLE

(75) Inventor: Masanori Hashiba, Aichi (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi (JP)

(21) Appl. No.: 12/740,537

(22) PCT Filed: Dec. 2, 2008
(86) PCT No.: PCT/JP2008/071900

§ 371 Date: Apr. 29, 2010

(30) Foreign Application Priority Data
Dec. 6, 2007 (JP) 2007-316406

(51) Int. Cl. B29B 9/02; B29C 45/72

(52) U.S. Cl. 264/140; 264/328.17

(57) ABSTRACT

The object of the present invention is to provide a method for producing a molded thermoplastic composition article, which enables the injection molding using a precursor molded body including a plant fiber and a thermoplastic resin while keeping the mechanical properties of the thermoplastic resin. The method for producing a molded thermoplastic composition article includes a chipping process of finely dividing at least one precursor molded body selected from a mat molded body and a board molded body each including a plant fiber and a thermoplastic resin to produce a chip, a non-heated pelletizing process of compressing the chip without heating to produce a pellet, and an injection molding process of injection molding the pellet to produce a molded thermoplastic composition article.

### FIELD OF THE INVENTION

The present invention relates to a method for the production of a molded thermoplastic composition article. Specifically, the present invention relates to a method for the production of a molded thermoplastic composition article containing a plant fiber and a thermoplastic resin by injection molding.

### BACKGROUND ART

Recently, plant resources which grow fast and absorb a large amount of carbon dioxide such as kenaf attract attention from a viewpoint of reduction in a carbon dioxide emission, fixing of carbon dioxide and the like and are expected to become a material mixed with a thermoplastic resin. Techniques using such a material are disclosed in the following Patent Documents 1 and 2.

[Patent Document 1] JP-A 2005-105245

[Patent Document 2] JP-A 2000-219812

### DISCLOSURE OF THE INVENTION

### Problems that the Invention is to Solve

In general, a material containing plant fibers is poor in fluidity and is difficult to be sufficiently molded using a molding method requiring fluidity of the material itself such as injection molding and extrusion molding. Thus, after a plant fiber and a thermoplastic resin are made into a nonwoven fabric and molded into a mat or a board, it is given final molding by a method such as heating compression. Since a mat or a board larger than a target shape is formed and then, an unnecessary part is removed so as to obtain the target shape in this molding method, there are problems that a material usage is larger than a target molded article and a material yield is poor. Therefore, a technique to reuse ends or the like generated after cutting is in demand. Moreover, injection molding in the reuse is requested. It is because a yield of the material usage is good and reusability is excellent in injection molding, which is preferable from viewpoints of environment, costs and the like.

Moreover, bending strength unique to the thermoplastic resin is generally lowered when the resin is mixed with a plant fiber. The reason is not known, but it is considered to be caused by difficulty in obtaining sufficient dispersibility between the thermoplastic resin and the plant fiber and close contact at an interface between thermoplastic resin and the plant fiber. A method realizing the injection molding without lowering the bending strength is required.

Although an injection molding is tried using a material containing a plant fiber and a thermoplastic resin in Patent Documents 1 and 2, use of ends or the like is not studied and a method for maintaining mechanical characteristics is not also studied.

The present invention was made in view of the above and has an object to provide a method for the production of a molded thermoplastic composition article capable of performing injection molding using a precursor molded body containing the plant fiber and the thermoplastic resin while mechanical characteristics of the thermoplastic resin is maintained.

### Means for Solving the Problems

The present invention is as follows.

(1) A method for the production of a molded thermoplastic composition article characterized by comprising a chipping process for forming chips by finely crushing at least one precursor molded body selected from the group consisting of a mat molded body and a board molded body that contain a plant fiber and a thermoplastic resin, a non-heated pelletizing process for obtaining a pellet by pressing without heating the chips, and an injection molding process for obtaining a molded thermoplastic composition article by subjecting the pellet to injection-molding.
(2) The method for the production of a molded thermoplastic composition article according to (1) above, wherein the pelletizing process is a process for forming the pellet using a roller-type molding machine provided with a die and a roller rotated in contact with the die by pressing the chips into the die by the roller and then extruding the pellet out of the die.
(3) The method for the production of a molded thermoplastic composition article according to (1) or (2) above, wherein the plant fiber is a kenaf fiber.
(4) The method for the production of a molded thermoplastic composition article according to any one of (1) to (3) above, wherein the thermoplastic resin is a polypropylene or a polylactic resin.

### EFFECT OF THE INVENTION

According to the method for the production of a molded thermoplastic composition article of the present invention, a molded thermoplastic composition article can be manufactured by injection molding using a precursor molded body containing the plant fiber and the thermoplastic resin while maintaining mechanical characteristics of the thermoplastic resin.

In the case where the pelletizing process is a process for forming the pellet using a roller-type molding machine provided with a die and a roller rotated in contact with the die by pressing the chips into the die by the roller and then extruding the pellet out of the die, particularly excellent moldability and high bending strength maintenance rate can be obtained.

In the case where the plant fiber is a kenaf fiber, a molded body having higher bending elastic modulus can be obtained. Additionally, since kenaf is a very fast growing annual grass and has excellent absorbitity of carbon dioxide, use of the kenaf can contribute to reducing an amount of carbon dioxide in the air, thus effectively utilizing forest resources and others.

In the case where the thermoplastic resin is a polylactic resin, it is a biomass material and its environmental load is small. That is, the resin is biosynthetic, and since a non-petroleum resin is used, use of petroleum resources can be restrained while practical characteristics including high mechanical strength or the like are obtained. In the case where the thermoplastic resin is polypropylene, handling is easy, and productivity can be improved. Further, high flexibility and excellent moldability can be obtained, and a molded body having high elastic modulus which can be molded into more versatile shapes can be obtained.

### BRIEF DESCRIPTION OF THE DRAWINGS

FIG. 1 is an explanatory diagram schematically illustrating each process in the present method.

FIG. 2 is a schematic perspective view illustrating an example of an essential part of a roller disc die-type molding machine.

### EXPLANATION OF THE REFERENCE NUMBERS

10: chipping apparatus (crushing machine), 20: non-heating pelletizing machine (roller disc die-type molding machine), 200: roller disc die-type molding part, 210: disc die, 211: through hole, 212: main rotating shaft insertion hole, 220: press roller, 221: concave-convex part, 230: main rotating shaft, 240: press-roller fixed shaft, 250: cutting blade, 30: injection molding machine, 31: mold part, 40: precursor molded body, 31: chip, 42: pellet.

### BEST MODE FOR CARRYING OUT THE INVENTION

Hereinafter, the present invention is described in detail.

### [1] Production Method of Molded Thermoplastic Composition Article

The method for the production of a molded thermoplastic composition article of the present invention is characterized by comprising a chipping process for forming chips by finely crushing at least one precursor molded body selected from the group consisting of a mat molded body and a board molded body that contain a plant fiber and a thermoplastic resin, a non-heated pelletizing process for obtaining a pellet by pressing without heating the chips, and an injection molding process for obtaining a molded thermoplastic composition article by subjecting the pellet to injection-molding.

That is, method for the production of a molded thermoplastic composition article of the present invention includes the “chipping process”, “non-heated pelletizing process”, and “injection molding process”.

### (1) Chipping Process

The “chipping process” is a process for forming chips by finely crushing at least one precursor molded body selected from the group consisting of a mat molded body and a board molded body that contain a plant fiber and a thermoplastic resin.

The “precursor molded body” is at least one of the mat molded body and board molded body that contain the plant fiber and the thermoplastic resin. Only one type of the mat molded body and board molded body may be used as the precursor molded body and two or more types thereof may be used.

Additionally, the precursor molded body may be the one manufactured only for the purpose of the production of the molded thermoplastic composition article in this method or may be an unnecessary one (ends or the like) generated during a process for the production of other molded articles.

The “mat molded body” is a molded body in which the plant fiber and the thermoplastic resin are molded into a mat shape (nonwoven fabric state) and is usually obtained using various methods for manufacturing nonwoven fabric. The density of the mat molded body is usually 0.3 g/cm³ or smaller and is usually 0.05 g/cm³ or higher. In addition, the thickness of the mat molded body is not particularly limited and is usually larger than 10 mm, preferably in the range from 10 to 50 mm, and particularly from 10 to 30 mm. It is usually 50 mm or less.

The mat molded body may be applied with machining after being molded into a mat shape. The heating machining may be applied, compression machining may be applied or moreover, other machining may be applied, for example. The above-mentioned density of this mat molded body is a value that can be measured according to JIS K7112 (Plastics—Methods of determining the density and relative density of non-cellular plastics).

The “board molded body” includes (1) a molded body in which a composite material containing the plant fiber and the thermoplastic resin is molded into a board shape (plate shape); (2) a molded body in which the board molded body of the above (1) is formed into a predetermined shape; and (3) ends generated as an unnecessary part of the molded body of the above (2). This board molded body is usually obtained by compression or heating compression (preforming) of the mat molded body. The density of the board molded body is not particularly limited and is usually larger than 0.3 g/cm³ and is usually 1.0 g/cm³ or less. Additionally, the thickness of the board molded body is not particularly limited and is usually 10 mm or less, preferably in the range from 0.1 to 5.0 mm, and more preferably from 1.0 to 3.0 mm.

The density of this board molded body is a value that can be measured according to JIS K7112 (Plastics—Methods of determining the density and relative density of non-cellular plastics) similarly to the density of the mat molded body.

The mat molded body may be obtained by any method. For example, the following methods (1) to (5) can lead to mat molded bodies.

(1) A method for the formation of a mat molded body in which a thermoplastic resin fiber obtained by making a thermoplastic resin into a fiber state is used and the thermoplastic resin fiber and the plant fiber are fiber-mixed by simultaneous deposition with air-lay or the like.
(2) A method for the formation of a mat molded body in which a dispersed liquid (including emulsion, suspension and the like) of a thermoplastic resin is sprayed to a plant fiber (or may be dried by means such as heating after the spraying) to form a resin-mixed fiber, and the resin-mixed fiber is formed into nonwoven fabric (by deposition with air-lay or the like).
(3) A method for the formation of a mat molded body by dipping a mat in which only a plant fiber is made into nonwoven fabric (by deposition with air-lay or the like) in a dispersed liquid (including emulsion, suspension and the like) of a thermoplastic resin (or may be dried by means such as heating after the dipping).
(4) A method for the formation of a mat molded body in which a powder thermoplastic resin is mixed with a plant fiber and the mixture is subjected to formation into nonwoven fabric (by deposition with air-lay or the like).
(5) A method for the formation of a mat molded body by further heating the mat molded body obtained by any one of the above method (1) to (4) so as to melt a thermoplastic resin contained in the mat molded body and by bonding the plant fibers together by the thermoplastic resin.

In these methods (1) to (5), the method may be used singly or in combination of two or more types thereof. Among the methods above, the method of the above (1) is preferable since processes are simple in mass production, manufacturing costs can be kept low, and high productivity can be obtained. In addition, the method of the above (2) and (3) are preferable since the plant fiber and the thermoplastic resin are dispersed in the obtained mat molded body more uniformly. Among these, the method (1) is more preferable.

In the method of the above (5), when the thermoplastic resin to be used is polypropylene or polylactic acid, a heating temperature is preferably in the range from 170° C. to 240° C., and more preferably from 190° C. to 220° C.

In the method (1), a form of the thermoplastic resin fiber is not particularly limited as long as it is fibrous. The fiber length is preferably 10 μM or longer, more preferably in the range from 10 to 150 mm, further preferably from 20 to 100 that, and particularly from 30 to 70 mm. Additionally, the fiber diameter thereof is usually 1 mm or shorter, preferably in the range from 0.01 to 1 mm, more preferably from 0.05 to 0.7 mm, and particularly from 0.07 to 0.5 mm. (The fiber length and fiber diameter for the fiber share the same meaning and the same measuring method with the fiber length and fiber diameter of the plant fiber, which will be described later, respectively).

Fiber-mixing of the plant fiber and the thermoplastic resin fiber (fiber-mixing process) may be performed in any way. Various methods such as air-laying, fleece knitting and carding can be used. These methods may be used singly or in combination of two or more types thereof. Moreover, after the fiber-mixing, an entangling process of the fibers may be performed. Examples of the method in the entangling process include needle punching, stitch bonding and the like. These methods may be used singly or in combination of two or more types thereof.

The board molded body may be obtained by any method. For example, the following methods (6) to (8) can lead to mat molded bodies. (6) A method for the formation of a board molded body by heating and compressing the mat molded body obtained by any one of the above method (1) to (4). (7) A method for the formation of a board molded body by compressing the mat molded body obtained by the above method (5) with use of a residual heat of the mat molded body without further heating (non-heated compressing). (8) A method for the formation of a board molded body by heating and compressing the mat molded body obtained by the above method (5).

In these methods (6) to (8), the method may be used singly or in combination of two or more types thereof. In the heating and compression in the methods of the above (6) and (8), heating and compression may be performed at the same time or compression may be performed after heating. The heating temperature that is a temperature inside the mat molded body and compression pressure are not particularly limited. In the case of using polypropylene and polylactic acid, the heating temperature is preferably in the range from 170° C. to 240° C., and more preferably from 190° C. to 220° C. The compression pressure is preferably in the range from 10 to 20 kgf/cm².

As the precursor molded body according to the present invention, a board molded body is particularly preferable in the above various precursor molded bodies. The more preferable is a board molded body obtained by forming a mat molded body in which the plant fibers in the mat obtained by the above method (1) are bonded by the above method (5), and further heating and compressing the mat molded body by the above method (8). That is, the precursor molded body is preferably a board molded body applied with twice or more of heating and compression (particularly, both a preliminary heating and compression process and this heating and compression process are preferably gone through) after the body is heated so that the thermoplastic resin is softened or melted. In other words, as the precursor molded body, a board molded body obtained such that the mat molded body obtained by fiber-mixing of the thermoplastic resin fiber and the plant fiber is heated and the thermoplastic resin contained in the mat molded body is softened or melted and then, compressed and gone through the preliminary heating and compression process in which the plant fibers are bonded together so as to obtain a board molded body, and this board molded body is heated so as to soften or melt the thermoplastic resin contained in the board molded body and then, compressed and gone through the heating and compression process for compression and molding. With such precursor molded body, the effect of using this method can be obtained particularly remarkably.

The precursor molded body contains the plant fiber and the thermoplastic resin as mentioned above.

The “plant fiber” is a fiber derived from a plant. Type of the plant fiber is not particularly limited. Examples of the plant fiber derived from a plant include a plant fiber obtained from a plant such as kenaf, manila hemp, sisal hemp, jute hemp, cotton, gampi, Mitsumata, Kozo, banana, pineapple, coconut, corn, sugarcane, bagasse, palm, papyrus, reed grass, esparto, Sabi grass, oat, rice plant, bamboo, various conifer trees (Japanese cedar, Japanese cypress, and others), broad leaf tree and others. (It may be woody part or non-woody part and may be derived from any position of the plant.) These plant fibers may be used singly or in combination of two or more types thereof.

Among these, a kenaf fiber, jute fiber and bagasse fiber are preferable in the present method since they have long fibers having small specific gravity and being strong, and grow faster. A fiber of kenaf with particularly large growth rate is more preferable. Bast fiber of the kenaf is particularly preferred. When the kenaf having a large growth rate is used, a fiber having high strength to the specific gravity can be obtained, and a light-weight and high-strength molded body can be obtained.

The kenaf in the present invention is a very fast growing annual grass having a woody stem and is classified into malvaceae. The kenaf includes hibiscus cannabinus and hibiscus sabdariffa of scientific names, and further includes Indian hemp, Cuban kenaf, kenaf, roselle, mesta, bimli hemp, ambary hemp, Bombay hemp and the like of conation names. In addition, jute is a fiber obtained from a jute hemp. The jute hemp includes a hemp including ouma (Corchorus capsularis L.), Jew's mallow, East Indian mallow, Mulukhiyya and a plant in Tiliacea.

The size and shape of the plant fiber contained in the precursor molded body are not particularly limited. The length of the fiber is usually 10 mm or longer. When the plant fiber having the length is used, a strength improvement effect can be obtained easily. The fiber length is preferably in the range from 10 to 150 mm, more preferably from 20 to 100 mm, and particularly from 30 to 80 mm. The above-mentioned fiber length means an average fiber length (ditto hereinafter) and is an average value for a total of 200 fibers by taking out a single fiber one by one at random and actually measuring a fiber length of single fiber with a ruler in the direct method according to JIS L1015.

The diameter of the fiber is usually 1 mm or shorter. When the fiber diameter is 1 mm or shorter, particularly high bending strength can be obtained. The fiber diameter is preferably in the range from 0.01 to 1 mm, more preferably from 0.05 to 0.7 and particularly from 0.07 to 0.5 mm. Moreover, 1 to 10 dtex is preferable. The above-mentioned fiber diameter means an average fiber diameter and is an average value for a total of 200 fibers by taking out a single fiber one by one at random and actually measuring a fiber diameter at the center in the length direction using an optical microscope.

The present method is suitable in the case where the fiber length is 50 mm or longer. Since a thermoplastic composition containing a plant fiber in this range (mixture of the plant fiber and the thermoplastic resin) has particularly low fluidity and difficulty in injection molding, heating and compression are applied for molding. Injection molding using this type of precursor molded body is particularly difficult, however, the injection molding can be easily performed according to the present method. Moreover, the mechanical characteristics can be maintained. The fiber length of the plant fiber contained in this precursor molded body is preferably in the range from 50 to 150 μm, more preferably from 60 to 100 ma, and particularly from 65 to 80 mm.

A fiber in the form out of the above range may be contained but the content is preferably 10% or less by weight of the total plant fiber.

The “thermoplastic resin” is not particularly limited and various resins can be used. Example thereof include a polyolefin such as polypropylene and polyethylene, a polyester resin such as an aliphatic polyester resin including polylactic acid, polycaprolactone and polybutylene succinate, and an aromatic polyester resin including polyethylene terephthalate, polybutylene terephthalate and polytrimethylene terephthalate, polystyrene, an acrylic resin including a resin obtained using methacrylate and/or acrylate, a polyamide resin such as nylon, a polycarbonate resin, a polyacetal resin, an ABS resin and the like. These resins may be used singly or in combination of two or more types thereof.

Among these, at least one of a polyolefin, a polyester resin, and a mixed resin (polylactic acid alloy) of polylactic acid as a polyester resin with other resin is preferable. Additionally, polypropylene is more preferable as the polyolefin. As the polylactic acid alloy, a mixed resin of at least one of polystyrene, ABS, nylon, polycarbonate, polypropylene and polybutylene succinate, with polylactic acid is preferable.

On the other hand, a polyester resin having biodegradability (hereinafter referred to simply as “biodegradable resin”) is preferable among the polyester. Examples of the biodegradable resin include (1) a hydroxycarboxylic acid-based aliphatic polyester such as a homopolymer of lactic acid, malic acid, glucose acid, 3-hydroxybutyric acid or the like, and a copolymer using at least one hydroxycarboxylic acid, (2) a polycaprolactone-based aliphatic polyester such as polycaprolactone, and a copolymer of at least one hydroxycarboxylic acid and caprolactone, (3) a diacid polyester such as polybutylene succinate, polyethylene succinate and polybutylene adipate, and the like.

Among these, polylactic acid, a copolymer of lactic acid and a hydroxycarboxylic acid other than lactic acid, polycaprolactone, and a copolymer of at least one hydroxycarboxylic acid and caprolactone are preferable, and polylactic acid is particularly preferable.

These biodegradable resins may be used singly or in combination of two or more types thereof.

Further, the lactic acid includes L-lactic acid and D-lactic acid. These lactic acids may be used singly or in combination.

The thermoplastic resin constituting the precursor molded body is the same type of resin as the initial thermoplastic resin used in order to form the precursor molded body, but its molecule might be made low molecular. That is, since the precursor molded body is applied with heating, compression and the like, apart of a polymer constituting the thermoplastic resin might be cut off and made low molecular. Particularly, when polypropylene is used, the molecule might be made low molecular.

With regard to weight ratio between the plant fiber and the thermoplastic resin contained in the precursor molded body, the content of the plant fiber is usually 30% or more by weight and is usually 95% or less by weight based on the entire precursor molded body. In the present method, the content of the plant fiber in the precursor molded body is preferably in the range from 30% to 90% by weight, more preferably from 35% to 85% by weight, and particularly from 40% to 80% by weight. When the precursor molded body containing the plant fiber in a preferable range, injection moldability and formability in the production method of the molded body, which will be described later, is improved.

The content of the plant fiber in this precursor molded body is maintained in the obtained molded thermoplastic composition article unless the thermoplastic resin is added in a post process.

The precursor molded body may contain other component in addition to the plant fiber and thermoplastic resin. In the case where a polylactic acid is contained as the thermoplastic resin, the other component may have a hydrolysis inhibitor. Example of the other component includes various antistatic agent, flame retardant, antibacterial agent, coloring agent and the like. These components may be used singly or in combination of two or more. However, a kneading aid such as rosin for aiding kneading the plant fiber and the thermoplastic resin may not be contained.

The “fine crushing” refers to making the precursor molded body into chips. A method for finely crushing (chipping) the precursor molded body is not particularly limited. Crushing, cutting, pulverization, a combination of them and the like can be used. That is, chipping can be performed using a crushing machine, a cutting machine, a pulverizing machine and the like. Crushing among them is preferable. That is, chipping with a crushing machine is preferable.

The precursor molded body can be crushed into a powder state using the crushing machine, for example. With the method, a reinforcement effect of the thermoplastic resin strength by having the plant fiber contained cannot be sufficiently obtained. Thus, fine crushing into a chip state is preferable. With regard to the size of the chip, the maximum side length is preferably 25 mm or shorter, and usually 1 mm or longer. The length is more preferably from 1 to 20 μm, further preferably from 1 to 15 mm, and particularly from 2 to 7 mm. Within this range, injection molding can be performed suitably, and a reinforcing function as the plant fiber can be also sufficiently exerted in the molded thermoplastic composition article to be obtained.

### (2) Non-Heated Pelletizing Process

The “non-heated pelletizing process” is a process for forming a pellet by pressing without heating the chips obtained in the chipping process. The apparatus and means in the pelletizing process are not limited so long as pelletization is performed without heating. Various compression molding methods are preferably used. Examples of the compression molding method include a roller-type molding method, an extruder-type molding method and the like. The roller-type molding method is a method using a roller-type molding machine. Molding is performed by pressing a mixture into a die with a roller rotated in contact with the die and then extruding it out of the die. Examples of the roller-type molding machine include a disc die-type (roller disc die-type molding machine) having different die shapes, and a ring die-type (roller ring die-type molding machine). On the other hand, the extruder-type molding method is a method using an extruder-type molding machine. Molding is performed by pressing a mixture into the die with use of a rotation of a screw auger and then extruding it out of the die. The method using a roller disc die-type molding method is particularly preferable as the compression molding method. The roller disc die-type molding machine used in this compression molding method has high compression efficiency and is suitable for the non-heated pelletizing process in the present method.

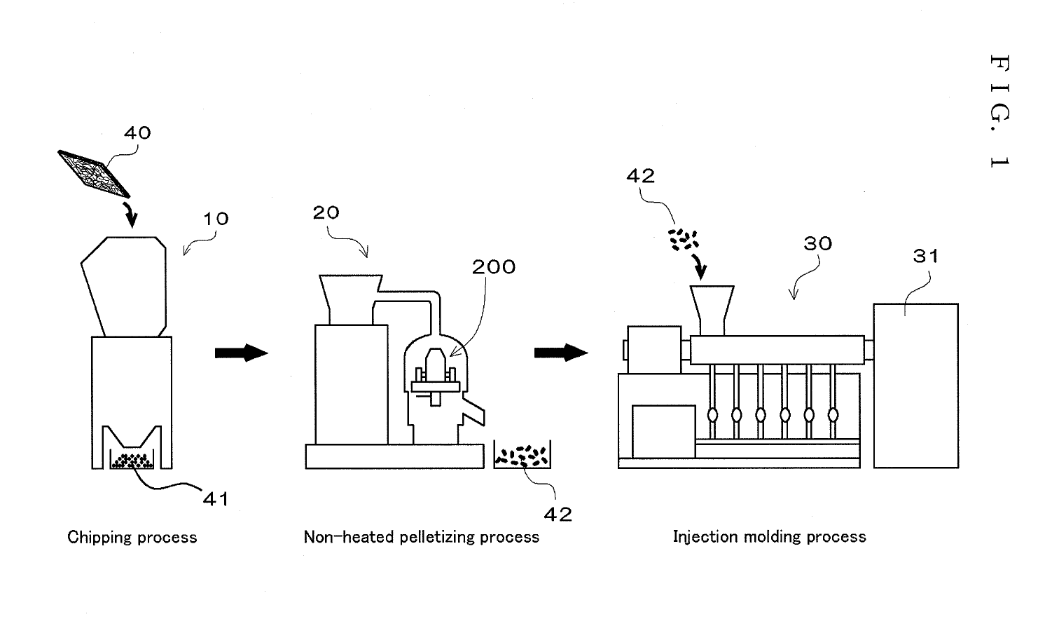

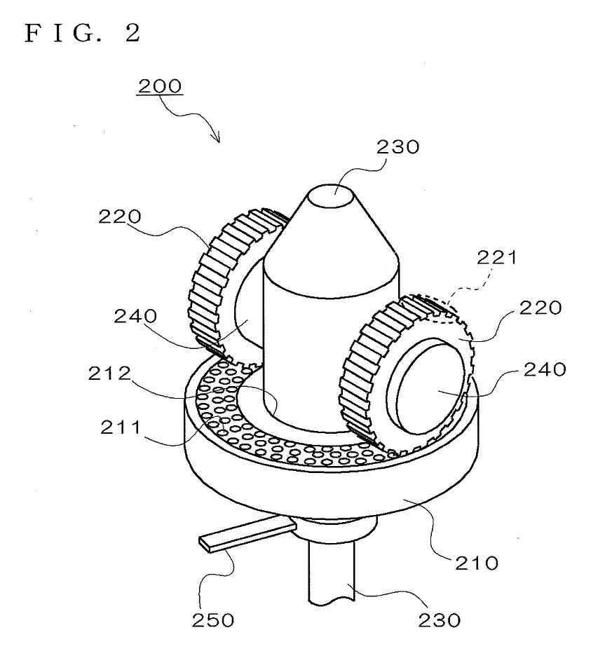

Moreover, the particularly preferable pelletization is using a roller disc die-type molding machine 20 (exemplified in FIG. 1 and its essential part in FIG. 2) in the present method. That is, the molding machine is a roller disc die-type molding machine (pelletizing apparatus) 20 having a roller disc die-type molding part 200 provided with a disc die 210 in which a plurality of through holes 211 are drilled, a press roller 220 rotated on the disc die 210 and pressing an article to be compressed (chip) into the through hole 211, and a main rotating shaft 230 that drives the press roller 220, wherein the disc die 210 has a main rotating shaft insertion hole 212 penetrating in the same direction as that of the through holes 211 and a press-roller fixed shaft 240 inserted through the main rotating shaft insertion hole 212 and disposed perpendicularly on the main rotating shaft 230, and the press roller 220 is pivotally supported rotatably by the press-roller fixed shaft 240 and rotated on the surface of the disc die 210 with rotation of the main rotating shaft 230.

The roller disc die-type molding machine 20 is preferably one in which the press roller 220 is provided with a concave-convex part 221 on the surface in addition to the above configuration. Additionally, a cutting blade 250 rotated with the rotation of the main rotating shaft 230 is preferably provided.

According to the roller disc die-type molding machine 20 in FIG. 2, a chip thrown from above the main rotating shaft 230 is caught by the concave-convex part 221 disposed on the press roller 220 and pressed into the through holes 211 and extruded out to the back face side of the disc die 210. The extruded-out strip-shaped thermoplastic resin composition (composition from which a form of the chip has been changed) is cut off to an appropriate length by the cutting blade 250 and pelletized, dropped downward and recovered as a pellet 42.

The size and shape of the pellet are not particularly limited. The preferable is a columnar shape (may be other shapes but a cylindrical columnar shape is preferable). Additionally, the maximum length is preferably 1 μm or longer and is usually 20 mm or shorter. The length is more preferably in the range from 1 to 10 mm, and particularly from 2 to 7 ma.

The pelletization of the thermoplastic resin composition is generally performed using a twin screw extruder. In the present method, pelletization is performed by pressing without heating. When the pelletization is performed by pressing without heating, smooth pelletization is realized with affected by fluidity of the thermoplastic resin composition (composition containing the plant fiber and the thermoplastic resin) constituting the chip. Moreover, without heating, it is considered that thermal deterioration of the thermoplastic resin contained in the chip can be suppressed, and the mechanical characteristics of the obtained molded body can be improved.

### (3) Injection Molding Process

The “injection molding process” is a process to form a molded thermoplastic composition article by injection molding of the pellet obtained in the non-heated pelletizing process. Various molding conditions, apparatus and the like used in the injection molding process are not particularly limited. It is preferable that they are appropriately selected according to the targeted molded article and properties, the type of the thermoplastic resin in use and the like.

In the present method, other pellets can be added (post-addition) other than the pellet obtained by chipping and pelletizing the precursor molded body (precursor molded body pellet) during injection molding. Examples of the other pellets (hereinafter referred to simply as “post-addition pellet”) include a pellet made of a thermoplastic resin of the same quality as that of the thermoplastic resin constituting the precursor molded body.

The “thermoplastic resins of the same quality” means [i] thermoplastic resins that are of the same type and are polymers of the same type of a constituting monomer unit; [ii] thermoplastic resins that are of the same type and are polymers of different types of constituting monomer units; or [iii] thermoplastic resins that are of the same or different types and are thermoplastic resins having at least one type of a caution monomer unit and mutual compatibility. The “thermoplastic resins of the same type” means resins selected from only one type of resin in resins classified into a polyolefin, a polyester resin, an acrylic resin, a polyamide resin, a polycarbonate resin, a polyacetal resin and the like. On the other hand, the “thermoplastic resins of different types” means resins not of “the same type” such as a combination of a polyolefin and a polyester resin.

Examples of the above [i] include a case in which the both are the same homopolymers or copolymers and at least one of chemical and physical properties such as a molecular weight and viscosity is different, and the like. Example wherein the both are copolymers includes a case in which both are copolymers having common two or more monomer units of the same type and whose proportions of the constituting monomer units are different from each other. Examples of the above [ii] include a case in which one is polyethylene and the other is polypropylene, and the like. Examples of the above [iii] include a case in which one is polyethylene and the other is ethylene propylene copolymer, and the like.

Further, in the cases of the above [ii] and [iii], supposing that the entire monomer unit of the thermoplastic resin constituting the precursor molded body is 100% by mol, the entire monomer unit of the thermoplastic resin constituting the post-addition pellet is 100% by mol, and a specific monomer unit occupying 50% or more by mol in the monomer unit of the thermoplastic resin constituting the precursor molded body is a major monomer unit, the thermoplastic resin constituting the post-addition pellet is of a resin having the major monomer unit at preferably 50% or more by mol and particularly in the range from 80% to 100% by mol.

The “thermoplastic resins of different types” are thermoplastic resins having none of the above [i] to [iii]. That is, the types of the thermoplastic resins are different and the resins do not have mutual compatibility.

### [2] Molded Article

The shape, size and thickness of the molded article obtained by the present production method are not particularly limited. The application thereof is not also limited. The molded article is widely used in fields of a vehicle including an automobile, a ship, an aircraft, an architecture and others. The fiber composite can be used as an interior material, an exterior material, a structural material and others of an automobile, a railcar, a ship, an aircraft and others. Among them, examples of an automobile supplies include an interior material for automobile, an instrument panel for automobile, an exterior material for automobile and others. Specific examples are a door base material, a package tray, a pillar garnish, a switch base, a quarter panel, a core material for armrest, a door trim for automobile, sheet-structured material, a console box, a dashboard for automobile, various instrument panels, a deck trim, a bumper, a spoiler, a cowling and others. Other examples are an interior material, an exterior material and a structural material of an architectural structure, furniture and others. That is, a door surface material, a door structural material, a surface material and a structural material for various furnitures (desk, chain, shelf, chest, and others), and others are included. Additionally a package, a container (tray and others), a member for protection, a member for partition and others may be included.

### EXAMPLE

The present invention will be described specifically using Examples.

### [1] Production of Molded Thermoplastic Composition Article

### (1) Example 1

Weights of a kenaf fiber having a fiber length of 70 mm and a polypropylene fiber having a fiber length of 51 mm were measured to be 50:50 in ratio, and they were subjected to an air-laying method to form a mat molded body having a thickness of 20 mm in which these fibers were mixed and deposited. The obtained mat molded body was heated and compressed so that an internal temperature of the mat molded body reaches 210° C. using a hot-plate presser heated to 250° C. to form a board molded body having a thickness of 2.5 mm. The obtained board molded body was heated in an oven set at 250° C. so as to heat the internal temperature of the board molded body to 210° C. After that, the board molded body was pressed for press-molding at a pressure of approximately 12 kgf/cm² using a die set to 40° C. to form into a door trim shape. An unnecessary part was cut off so as to have a door-trim base material. At this time, the removed unnecessary part (ends) was collected as a precursor molded body (reference numeral 40 in FIG. 1).

The precursor molded body was crushed using a crushing machine “Z10-420” (type name) manufactured by HORAI Co, Ltd. (reference numeral 10 in FIG. 1) (chipping process). The crushed material was filtered and only the crushed chip having passed through a sieve of a 5.0 mesh was used.

Subsequently, the chip (reference numeral 41 in FIG. 1) was charged into a roller disc die-type molding machine “KP280” (type name) manufactured by KIKUKAWA IRON WORKS, INC. (reference numeral 20 in FIG. 1) having a diameter of through hole of 4.2 mm (reference numeral 211 in FIG. 1). Pelletization was conducted at a feeder frequency of 20 Hz without heating to form a cylindrical columnar pellet having a diameter of approximately 4 mm and a length of approximately 5 μm (reference numeral 42 in FIG. 1) (non-heated pelletizing process).

After that, the pellet was dried at 100° C. for 24 hours in an oven and then, the pellet (reference numeral 42 in FIG. 1) was continuously charged into an injection molding machine “SE100DU” (type name) manufactured by Sumitomo Heavy Industries, Ltd. (reference numeral 30 in FIG. 1). Injection molding was performed under a condition of a cylinder temperature of 190° C. and a die (reference numeral 31 in FIG. 1) temperature of 40° C. to form a molded thermoplastic composition article as a test specimen in a rectangular plate shape having a thickness of 4 mm, a width of 10 mm, and a length of 80 mm for Example 1 (injection molding process).

### (2) Examples 2 to 4

The non-heated pelletizing process was performed similarly to the above (1). The injection molding process was performed after a pellet (post-addition pellet) consisting of the same thermoplastic resin as the thermoplastic resin constituting the precursor molded body was added to the pellet obtained by the non-heated pelletizing process so that composition proportions in Table 1 was realized. Molded thermoplastic composition articles (test specimen) were obtained for Examples 2 to 4.

### (3) Example 5

The precursor molded body was obtained similarly to the above (1) except that polylactic fiber having a fiber length of 51 mm was used instead of the polypropylene fiber so that the weight ratio of the kenaf fiber and the polylactic fiber becomes 50:50 in preparation of the precursor molded body in the above (1). After that, the molded thermoplastic composition article (test specimen) was obtained for Example 5 in the same manner as the above (1) by performing the chipping process, non-heated pelletizing process and injection molding process.

### (4) Comparative Example 1

After the chipping process was performed similarly to the above (1), a heating pelletizing process was performed using a twin screw extruding machine instead of the non-heated pelletizing process. In the heating pelletizing process, extrusion was conducted at 190° C. using a twin screw extruding machine having φ40 mm and L/D 32, manufactured by Reserch Laboratory of Plastics Technology Co., Ltd and the composite was fed using a conveyer while being air-cooled and then, cut off and the pellet was prepared. Then, the injection molding process was performed similarly to the above (1) to form a molded thermoplastic composition article (test specimen) for Comparative Example 1.

### (5) Comparative Example 2

The precursor molded body was obtained similarly to the above (3), and then the chipping process was performed similarly to the above (1). Subsequently, the heating pelletizing process was performed similarly to the above (4), and then the injection molding process was performed similarly to the above (1) to obtain a molded thermoplastic composition article (test specimen) for Comparative Example 2.

### (6) Comparative Example 3

Pellet consisting of polypropylene “NOVATEC BC06C” (trade name) manufactured by Japan Polypropylene Corp. was just charged continuously without using kenaf fiber into an injection molding machine “SE100DU” (type name) manufactured by Sumitomo Heavy Industries, Ltd. Injection molding was conducted under a condition of a cylinder temperature of 190° C. and a die temperature of 40° C. to form a molded thermoplastic composition article (test specimen) in a rectangular plate shape having a thickness of 4 mm, a width of 10 ram and a length of 80 MU for Comparative Example 3.

### (7) Comparative Example 4

Pellet consisting of polylactic acid “U'sS-12” (trade name) manufactured by Toyota Motor Corp. was just charged continuously without using kenaf fiber into an injection molding machine “SE100DU” (type name) manufactured by Sumitomo Heavy Industries, Ltd. Injection molding was conducted under a condition of a cylinder temperature of 190° C. and a die temperature of 40° C. to form a molded thermoplastic composition article (test specimen) in a rectangular plate shape having a thickness of 4 mm, a width of 10 mm and a length of 80 mm for Comparative Example 4.

### [2] Characteristic Evaluation of Molded Thermoplastic Composition Article

Bending strength and bending elastic modulus of the molded articles obtained in the above [1] for Examples 1 to 5 and Comparative Examples 1 to 4 were measured. In this measurement, a test specimen in the rectangular plate shape was used having a thickness of 4 nut, a width of 10 mm and a length of 80 mm. The bending elastic modulus of the specimen was measured according to JIS K7171 by supporting the test specimen at two supporting points (radius of curvature: 5 mm) with a distance between the supporting points (L) of 64 mm, under a load applied at a rate of 2 ma per minute from a working point (radius of curvature: 5 mm) arranged at the center between the supporting points. The result is shown in Table 1.

TABLE 1

| | | | | | Bending |
|---|---|---|---|---|---|
| | Thermoplastic resin molded article | | | Bending | elastic |
| | kenaf fiber | PP | PLA | strength | modulus |
| | (% by | (% by | (% by | at 23° C. | at 23° C. |
| | weight) | weight) | weight) | (MPa) | (MPa) |
| Example 1 | 50 | 50 | — | 52 | 6200 |
| Example 2 | 40 | 60 | — | 52 | 5300 |
| Example 3 | 30 | 70 | — | 51 | 4200 |
| Example 4 | 20 | 80 | — | 51 | 3100 |
| Example 5 | 50 | — | 50 | 102 | 8000 |
| Comparative | 50 | 50 | — | 45 | 5800 |
| Example 1 | | | | | |
| Comparative | 50 | — | 50 | 90 | 7800 |
| Example 2 | | | | | |
| Comparative | — | 100 | — | 50 | 1700 |
| Example 3 | | | | | |
| Comparative | — | — | 100 | 100 | 3300 |
| Example 4 | | | | | |

In the table, “PLA” and “PP” are respectively polylactic acid and polypropylene.

### [3] Effect of Examples

In Examples 1 to 4, injection molding could be performed using a board molded body as the precursor molded body. The bending strength of the molded body in Comparative Example 3 using polypropylene was 50 MPa. On the other hand, the bending strengths in Examples 1 to 4 were in the range from 51 to 52 MPa, and it was found that molding was possible while maintaining the bending strength where only polypropylene was used.

When Example 1 wherein non-heated pelletizing process was employed is compared with Comparative Example 1 wherein heating pelletizing process was employed, the bending strength in Comparative Example 1 was 45 MPa, while that of Example 1 was 52 MPa. It was found in Example 1 that not only that the bending strength in Comparative Example 1 was maintained, but the bending strength exceeding that was imparted, and that the bending strength was remarkably reinforced by approximately 16% by going through the non-heated pelletizing process. Additionally, the bending elastic modulus was 5,800 MPa in Comparative Example 1, while that of Example 1 was 6,200 MPa. It was found that the bending elastic modulus exceeding the bending elastic modulus in Comparative Example 1 was given to Example 1, and the bending elastic modulus was reinforced by 400 MPa by going through the non-heated pelletizing process.

Moreover, it was found in Examples 1 to 4 that the bending strength was maintained while controlling the bending elastic modulus even if polypropylene was post-added in molding.

In Example 5, the injection molding could be performed using a board molded body as the precursor molded body. The bending strength of the molded body in Comparative Example 4 using polylactic acid was 100 MPa. On the other hand, the bending strengths in Example 5 was 102 MPa, and it was found that molding was possible while maintaining the bending strength where only polylactic acid was used.

When Example 5 wherein non-heated pelletizing process was employed is compared with Comparative Example 2 wherein heating pelletizing process was employed, the bending strength in Comparative Example 2 was 90 MPa, while that of Example 5 was 102 MPa. It was found in Example 5 that not only that the bending strength in Comparative Example 2 was maintained, but the bending strength exceeding that was imparted, and that the bending strength was remarkably reinforced by approximately 13% by going through the non-heated pelletizing process. Additionally, the bending elastic modulus was 7,800 MPa in Comparative Example 2, while that of Example 5 was 8,000 MPa. It was found that the bending elastic modulus exceeding the bending elastic modulus in Comparative Example 1 was given to Example 1, and the bending elastic modulus was reinforced by 200 MPa by going through the non-heated pelletizing process.

### INDUSTRIAL APPLICABILITY

The production method of the molded thermoplastic composition article of the present invention is widely used in fields of a vehicle, an architecture and others. The molded thermoplastic composition article is suitable used as an interior material, an exterior material, a structural material and others of an automobile, a railcar, a ship, an aircraft and others. Among them, examples of an automobile supplies include an interior material for automobile, an instrument panel for automobile, an exterior material for automobile and others. Specific examples are a door base material, a package tray, a pillar garnish, a switch base, a quarter panel, a core material for armrest, a door trim for automobile, sheet-structured material, a console box, a dashboard for automobile, various instrument panels, a deck trim, a bumper, a spoiler, a cowling and others. Other examples are an interior material, an exterior material and a structural material of an architectural structure, furniture and others. That is, a door surface material, a door structural material, a surface material and a structural material for various furnitures (desk, chain, shelf, chest, and others), and others are included. Additionally, the molded thermoplastic composition article is suitable as a package, a container (tray and others), a member for protection, a member for partition and others.

1. A method for the production of a molded thermoplastic composition article characterized by comprising:
a chipping process for forming chips by finely crushing at least one precursor molded body selected from the group consisting of a mat molded body and a board molded body that contain a plant fiber and a thermoplastic resin;
a non-heated pelletizing process for obtaining a pellet by pressing without heating said chips; and
an injection molding process for obtaining a molded thermoplastic composition article by subjecting said pellet to injection-molding.

2. The method for the production of a molded thermoplastic composition article according to claim 1,
wherein said pelletizing process is a process for forming said pellet using a roller-type molding machine provided with a die and a roller rotated in contact with said die by pressing said chips into said die by said roller and then extruding said pellet out of said die.

3. The method for the production of a molded thermoplastic composition article according to claim 1,
wherein said plant fiber is a kenaf fiber.

4. The method for the production of a molded thermoplastic composition article according to claim 1,
wherein said thermoplastic resin is a polypropylene or a polylactic resin.

5. The method for the production of a molded thermoplastic composition article according to claim 1,
wherein said precursor molded body is a board molded body which is obtained by fiber-mixing a thermoplastic resin fiber and said plant to form a mat molded body; heating said mat molded body to soften or melt the thermoplastic resin in said mat molded body; compressing to form a molded body in which plant fibers are bound with said thermoplastic resin; heating said molded body to soften or melt the thermoplastic resin in said molded body; and compressing.

6. The method for the production of a molded thermoplastic composition article according to claim 1,
wherein the content of said plant fiber in said precursor molded body is in the range from 30% to 95% by weight based on the total of said precursor molded body.

7. The method for the production of a molded thermoplastic composition article according to claim 1,
wherein the side length of said chip is in the range from 1 to 25 mm.

8. The method for the production of a molded thermoplastic composition article according to claim 1,
wherein a pellet made of a thermoplastic resin of the same quality as that of said thermoplastic resin constituting said precursor molded body is used with said pellet which is obtained in said non-heated pelletizing process, in said injection molding process.
